(19) United States
(12) Patent Application Publication
(10) Pub. No.: US 2006/0157878 A1
(43) Pub. Date: Jul. 20, 2006

(54) Installation comprising a machine for the production of tablets which are intented, in particular, for therapeutic use

(75) Inventors: Christophe Brisset, Petit-Quevilly (FR); Florian Battung, Rouen (FR)

Correspondence Address: FOLEY AND LARDNER LLP;SUITE 500, 3000 K STREET NW, WASHINGTON, DC, 20007, US

(73) Assignee: ETHYPHARM

(21) Appl. No.: 10/563,614

(22) PCT Filed: Jul. 7, 2004
(86) PCT No.: PCT/FR04/01764

§ 371 Date: Mar. 23, 2006

(30) Foreign Application Priority Data
Jul. 7, 2003 (FR) 03/08268

(51) Int. Cl. B28B 7/04

(52) U.S. Cl. 264/39; 425/345; 425/143

(57) ABSTRACT

The invention relates to an installation comprising a machine (4) for the production of tablets, said machine comprising at least one chamber (6). The inventive installation comprises means for releasing a gas into the chamber and for moving the gas around same.

The invention concerns the production of tablets, and in particular tablets comprising a substance for therapeutic or cosmetic use. It can concern tablets comprising Ibuprofen for example.

The Ibuprofen molecule has a softening point of 42° C. and a melting point of 70° C. One is familiar with the creation of Ibuprofen tablets from a powder by means of a machine comprising a series of dies and punches between which the tablets are formed. Within the machine, the dynamics of compression generate rises in temperature which cause a softening of the raw materials used for the production of the tablets. This can be followed by a problem of adherence of the powder or of the tablets within the machine, this being detrimental for its correct operation.

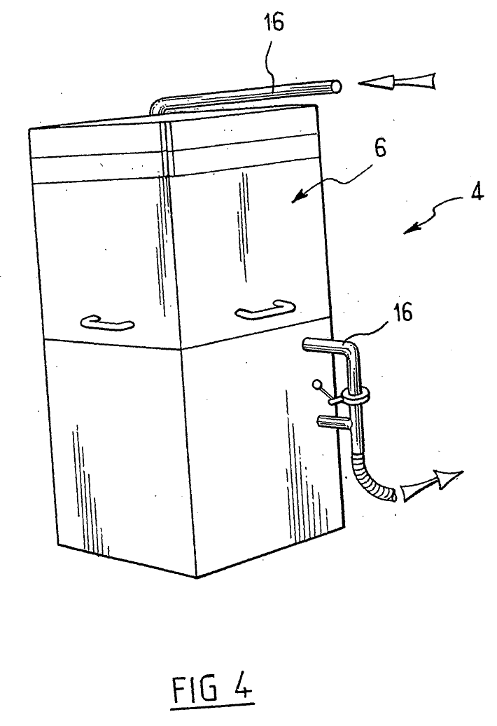

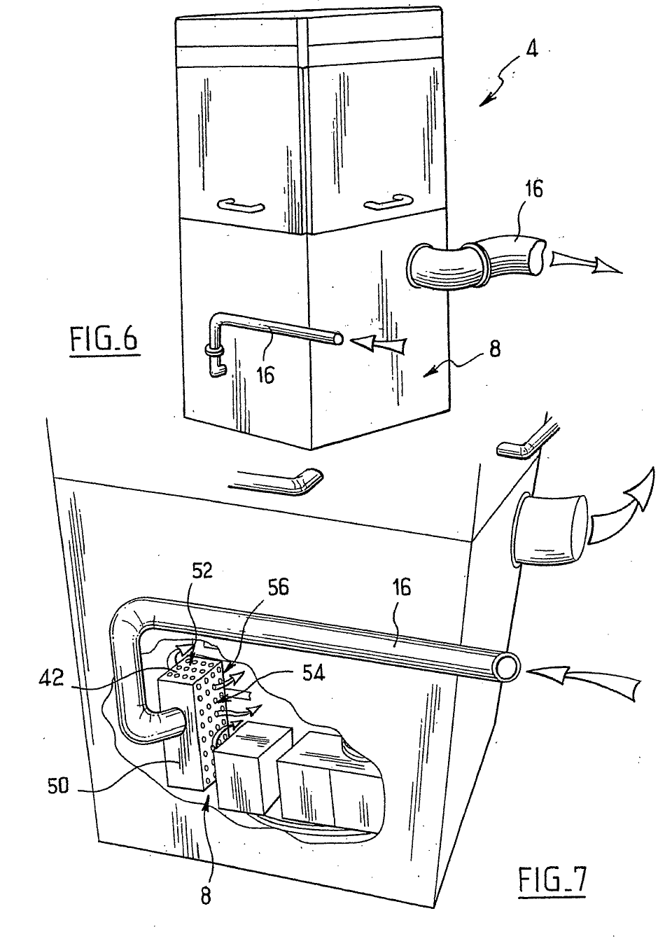

FIG. 3 of document FR-2 440 188 recites a machine for the production of tablets, in which certain parts have internal channels that carry a cooling fluid. Such cooling resources must be allowed for in the design and production of the machine, so that this process cannot be implemented on an existing machine without expensive modifications to the latter. In another method of implementation illustrated in FIG. 7, the document suggests enclosing the entire machine in an enclosure that contains a gas whose temperature is controlled. However the energy expended to maintain the temperature of the gas, and therefore the temperature of the machine, at the desired level, is very high.

One objective of the invention is to solve the problem of adherence during the production of the tablets, using resources that are easily adaptable to an existing machine, and whose implementation does not require an excessive expenditure of energy.

To this end, the proposal according to the invention is an installation comprising a machine for the production of tablets, where the machine has at least one enclosure, and where the installation includes means for injecting a gas into the enclosure and distribute it throughout the enclosure.

Thus, the invention can easily be adapted to an existing machine without excessive cost. Moreover, the circulation of the gas in the enclosure causes the latter to cool very efficiently without expending too much energy.

Advantageously, said means are arranged to control the temperature of the gas.

Thus, it is possible to achieve the desired temperature for the production of the tablets more efficiently, and in particular more rapidly.

Advantageously, the said resources are arranged to control the relative humidity of the gas. In fact, the relative humidity of the gas surrounding the machine and in particular the devices for manufacturing the tablets, is also a parameter that is important in order to prevent adherence during production.

The machine can also have at least any of the following characteristics

said means are arranged to control the temperature of the gas;

said means are arranged to control the temperature of the gas at a predetermined location upstream of the enclosure, to ensure that the temperature of the gas in the enclosure reaches a predetermined value;

said means are arranged to control the temperature of the gas at a predetermined location upstream of the enclosure, in order to ensure that the temperature reaches a predetermined value;

said means are arranged to cool and/or heat the gas;

said means include at least one particle filter;

said means include at least one fan, placed upstream or downstream of the enclosure, for example;

the enclosure includes devices for shaping of the tablets;

the enclosure includes a motor;

the enclosure includes an electronic device;

the enclosures are at least two in number and the machine includes resources to inject a gas into each enclosure and to distribute it;

it includes gas conduits arranged to feed the enclosures with gas by means of a parallel arrangement;

the means are partly common to the enclosures;

said means include at least one gas conduit connected to the enclosure so that it can be removed;

it includes a stopper to interrupt a flow of gas between the enclosure and the remainder of the installation;

said means are arranged to control a flow of gas associated with the enclosure by allowing the choice of one flow from various non-zero flow values;

said means include a diffusion box placed in the enclosure and having at least two openings for entry of the gas into the enclosure;

the openings are located on different faces of the diffusion box;

the tablets include a substance for therapeutic or cosmetic use; and

the tablets include Ibuprofen.

The invention also proposes a method for the production of tablets in a gas which is injected into an enclosure that forms part of a machine for the production of tablets, and distributes it throughout the enclosure.

The method can have at least one of the following characteristics:

the temperature of the gas is controlled;

the temperature of the gas is controlled at a predetermined location upstream of the enclosure in order to ensure that the temperature of the gas in the enclosure reaches a predetermined value; and

the temperature of the gas is controlled at a predetermined location upstream of the enclosure in order to ensure that the temperature reaches a predetermined value.

Other characteristics and advantages of the invention will appear from the following description of one preferred method of implementation, provided by way of a non-limited example, with reference to the appended drawings in which:

FIG. 1 is an overall diagram of the installation according to one preferred embodiment of the invention;

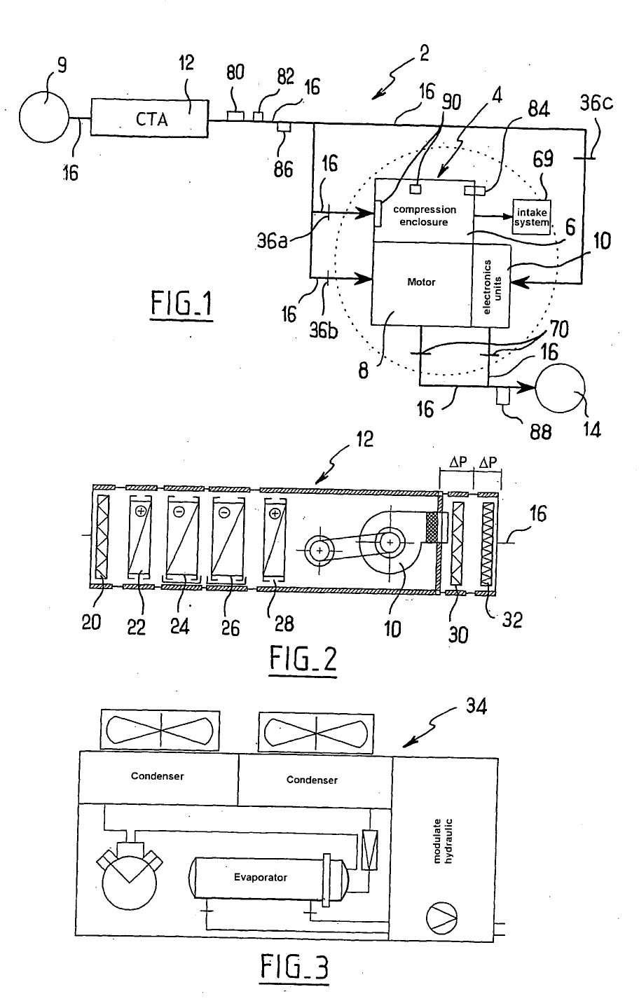

FIG. 2 is a schematic plan view of the air-treatment unit of the installation of FIG. 1;

FIG. 3 is a schematic view of one part of air heating and cooling system of the installation of FIG. 1;

FIG. 4 is a partial perspective view of the machine of the installation of FIG. 1, showing the conduits associated with the compression enclosure;

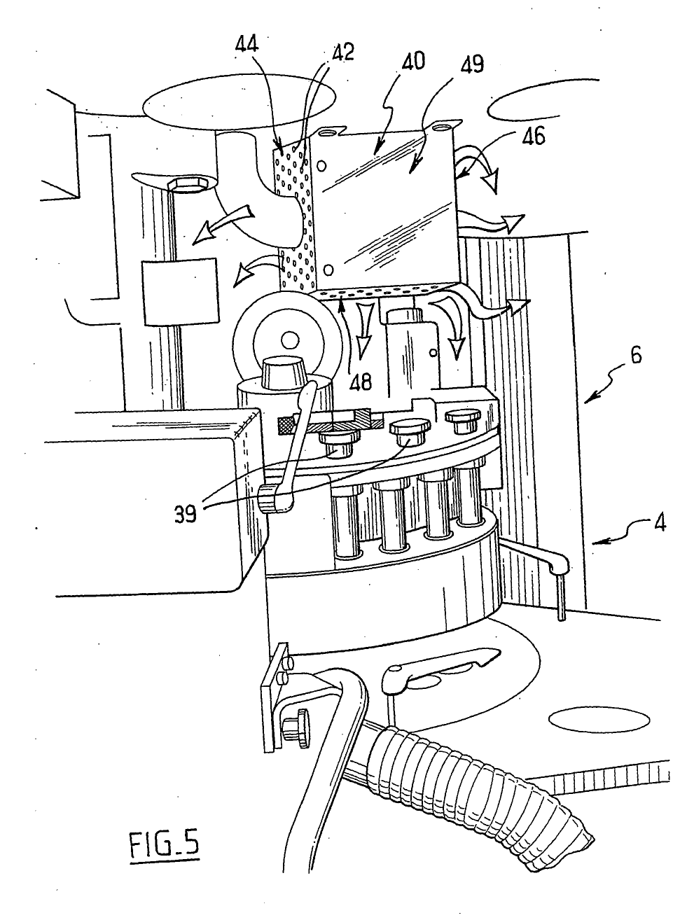

FIG. 5 is a partial perspective view of the interior of the compression enclosure of the machine of FIG. 1;

FIG. 6 is a similar view to FIG. 4 showing a conduit associated with the motor unit;

FIG. 7 is a perspective view with a partial cut-away showing the interior of the motor unit;

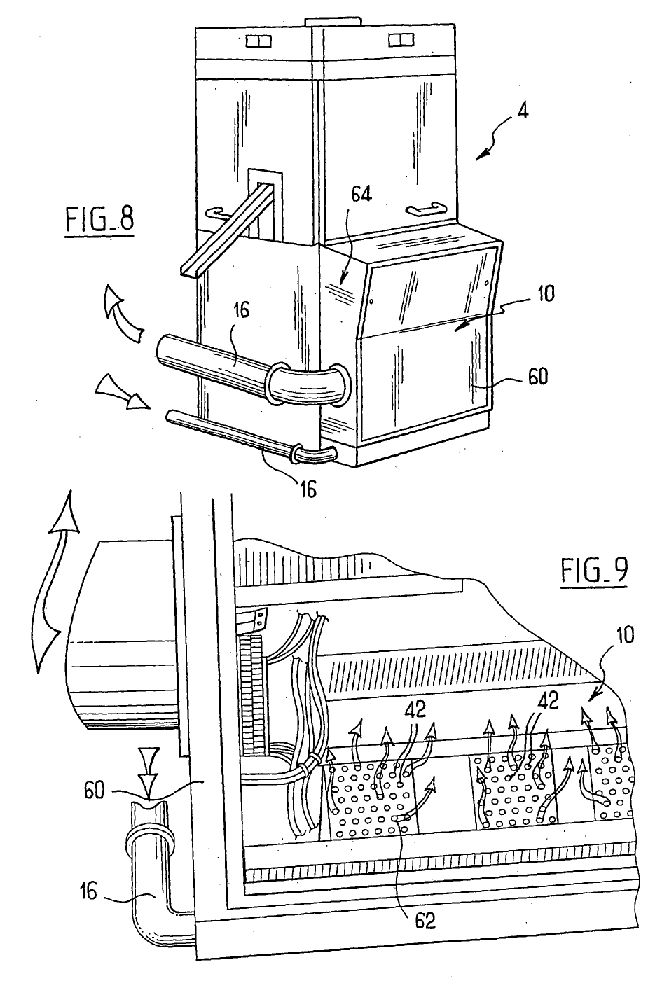

FIG. 8 is a similar view to FIG. 4 showing the conduits associated with the electronics unit; and

FIG. 9 is a perspective view with a partial cut-away showing the interior of the electronics unit.

In the embodiment of the invention that will be described, the installation 2 includes a machine 4 which is used for the production of tablets, for therapeutic use and comprising Ibuprofen, where this machine is of a type that is already known. With reference to FIG. 1, it includes, conventionally, a compression enclosure 6 containing devices for the production of tablets, a motor unit 8 comprising, in particular, a motor operating the devices located in the compression enclosure, and an electronics unit 10 performing regulation of the machine. The compression enclosure, the motor unit, and the electronics unit are contiguous with each other and enclosed in a common housing. Such a machine is of the type, for example, that is described in the aforementioned document FR-2 440 188, and will not be described below in detail with all of its constituent elements.

The installation 2 also includes resources to cool the machine 4 by the feeding of cool air. In particular, it includes an upstream air-feed fan 9. It also includes an air-treatment unit 12 performing filtration, de-humidification and possibly heating or cooling of the air. It also includes a downstream extraction fan 14. Finally, it includes conduits or shafts 16, in stainless steel for example, distributing the gas throughout the different parts of the installation 2. Thus a first common shaft 16 lies downstream of the air-treatment unit and communicates with three other shafts connected in an assembly in parallel with the compression enclosure 6, the motor unit 8, and the electronics unit 10 respectively. Finally, two shafts 16 lie in a parallel assembly downstream of the motor unit and the electronics unit respectively. They communicate with a common shaft 16, itself in communication with the downstream feeding fan 14.

Thus, as can be seen, in this installation the air is fed in at three points of the compressor 4. It is first fed into the compression enclosure 6, as close as possible to the manufacturing devices, in order to provide cool air to negate the calories generated by the rapid motion of the manufacturing turret and by friction.

The air is also fed into the motor unit 8 in order to minimise the phenomena of heat diffusion in the direction of the adjacent compression enclosure, these phenomena being due to heating of the mechanical components of the motor.

Finally, and in a similar manner, feeding cool air into the electronics unit 10 minimises the phenomena of heat diffusion in the direction of the motor unit and the compression enclosure, these phenomena being due to heating of the electrical and electronic components.

The air-treatment unit 12 is preferably installed in an equipment room other than the room accommodating the compressor 4. This unit is used to perform the conditioning of the blown air. It also controls its quality, in particular by filtration, de-humidification and, where appropriate, heating and/or cooling of the air. It can be a unit of Hydronic make, of the CCM20 type, capable of providing an air flow of 1500 m³/hour and offering an available pressure of 350 Pa. In this present example, this unit operates with fresh air only, meaning that it does not take in air that has already passed through the machine.

With reference to FIG. 2, we are now going to present the different devices making up this unit 12 from left to right, that is in the direction of flow of the gas, with the air entering at the left end of the unit and leaving at the right end. The unit includes a particle filter 20 of the F6 type (to the EN779 standard). Downstream of the filter 20, the unit includes first an electric heat exchanger 22 with a power of 7.8 kW, and then an exchanger 24 operating with chilled water at a temperature of between 0 and 5° C. with a power of 24 kW. This is followed by a second chilled water exchanger 26. Next comes an electric heat exchanger 28 with a power of 15.6 kW. Downstream of these elements, the unit includes the aforementioned upstream feeding fan 9 which, in this present example, is therefore incorporated into the unit and provides a flow of 1500 m³/hour, offering an available pressure of 300 Pa. Downstream of the latter we find an F8 30 particle filter (to the EN779 standard) and an H13 32 particle filter (to the EN1822 standard).

All these filters have, in particular, the function of rendering the gas “clean”, that is compatible with pharmaceutical use, in order to enable it to come into contact with the tablets. In this present example, differential pressure measurements are taken regularly at the location of these last two filters, in order to effect surveillance of the fouling of these filters.

The dimensioning calculations of the machine have been carried out using various climatic and geographical data. Thus, the aim is that, in both summer and winter, the machine is maintained at a vacuum of 0 to 30 Pa, the temperature in the compression unit at 25° C., and the humidity of the blown air below 5 g of water per kg of dry air. We have taken as assumptions that in winter the outside conditions will be −7° C. with 90% relative humidity, and in summer the outside temperature will be 29° C. with 43% relative humidity.

Each cold exchanger 24, 26 in the unit 12 is fed from a common chilled water circuit connected to a chilling unit 34 as illustrated in FIG. 3. This unit is associated with header tanks of 100 litres and 300 litres respectively, in order provide a high degree of stability regarding the accuracy of the water temperature.

With reference to FIG. 1, downstream of the unit 12, the air is carried in a shaft 16 which, as illustrated, is divided into 3 parts:

a shaft for feeding the air toward the compression enclosure 6;

a shaft for feeding the air toward the motor unit 8); and

a shaft for feeding the air toward the electronics unit 10.

A feeding damper 36a, 36b and 36c is placed in the path of each of these last three shafts. This can be a motor-driven damper 36a in the path toward the compression enclosure. Dampers 36b and 36c in the path toward the motor and electronics units are not motor-driven. The motor-driven damper 36a is used to isolate the compression enclosure in a sealed manner in relation to the air-feed system in the event of shutdown of the machine. This may be a pharmaceutical constraint imposed in order to prevent any contamination of the air-feed system by powder present in the machine. Each of these dampers can also be used to modify the flow of air in each of the associated shafts 16, so as to vary this flow between different non-zero flow values, or even to totally close off the shaft. The shafts 16 are in AISI 316 L stainless steel.

Each of these three shafts start in the room accommodating the unit 12 and end in the room housing the compressor 4. This room has a controlled atmosphere. In this present example, each of these three shafts 16 has a removable middle part, and two other parts, upstream and downstream respectively, located on either side of the removable part and permanently fixed respectively to the room and to the machine. The presence of these removable sections allows the machine 4 to be used if necessary in its original configuration, to be achieved without the need for a cool-air feed. In this case, stoppers are installed, in stainless steel for example, on the sections of fixed shaft associated with the machine, in order to guarantee the basic performance of the machine.

With reference to FIGS. 4 and 5, the implementation of cooling in the compression enclosure 6 will now be presented in greater detail. The shaft 16 associated with the compression enclosure 6 arrives there via the top of the enclosure. It is used to distribute the air as close as possible to the compression dies 39. Within the enclosure 6 is positioned a diffusion box or deflector 40, in the shape of a rectangular parallelepiped and made of steel sheeting. This diffusion box receives the air arriving from the shaft 16. It has openings 42 on its vertical lateral faces 44 and 46, as well as on its lower 48 and rear faces the latter is not illustrated. This allows a good distribution of the air flow in order to ensure perfect diffusion of the air inside the compression enclosure. In this present example, the front face 49 of the deflector does not have any air exit opening. In fact, this face looks into the enclosure 6. The compressor is also equipped with an oil-spraying system which is used to perform lubrication of the dies 39 in a manner which is already familiar, this being a very volatile substance. If this face of the diffusion box were not to be closed off, the blown air would give rise to a cloud of oil spray within the enclosure 6 which would be prejudicial to the manufacturing process. The deflector 40 is located in the upper part of the enclosure 6. The downstream shaft 16, used to extract the gas from the enclosure 6, opens into the lower part of the enclosure, on a face of the enclosure opposite to the deflector.

The cooling resources of the enclosure associated with the motor unit 8 are illustrated in FIGS. 6 and 7. The air is sent directly into the motor unit in order to reduce the temperature of this unit and thus to minimise heat diffusion from the motor unit toward the compression enclosure 6. A diffusion box 50 or deflector, also in perforated steel sheeting, is installed inside the enclosure 8 of the motor unit. The deflector is positioned on the lower horizontal face of the enclosure 8 and is open on its upper 52, front 54 and lateral vertical 56 faces, having a network of orifices 42 on each face. The air extraction shaft 16 is positioned on a face other than the face of the enclosure 8 accommodating the air intake shaft toward the deflector.

The implementation of cooling in the electronics unit 10 is illustrated finally in FIGS. 8 and 9. As for the motor unit 8, the air is sent directly into the electronics unit in order to reduce the temperature of this unit and thus to minimise the heat diffusion from the electronics unit toward the compression enclosure.

To this end, the air is led in via the top of an electrical cabinet 60 in the electronics unit 10. Here again, a deflector or diffusion box is provided for introduction of the air into the enclosure 10. The deflector is positioned in the lower part of the enclosure after removal of the fan generally located in the lower part of the cabinet. The diffusion box is open at its upper face, having several networks of openings 42. This system results in a good distribution of the air flow in order to ensure perfect diffusion of the air inside the electronics unit. The upstream shaft 16 introducing the air into the enclosure 10 is located in the bottom part of the cabinet, while the downstream shaft 16 extracting the air from this enclosure is located in the upper part of the motor unit. The two shafts are associated with the same lateral wall 64 of the cabinet.

As can be seen, the air is extracted via the shafts 16 only at two points 30 of the machine, namely the motor unit 8 and the electronics unit 10. This extraction is achieved using the extraction fan 14. Like the upstream shafts, the two downstream shafts 16 associated with the motor and electronics units are equipped with motor-driven extraction dampers 70 which are used to isolate, in a sealed manner, the extraction network of the air-feed system in the event of a shutdown of the machine. This pharmaceutical constraint is used to prevent any contamination of the air-feed system by contaminated air that has passed through the mechanical and electronic components.

The machine includes resources to control the air-feed system, which are used in particular to set the different parameters and operating procedures. This system can include a terminal recessed into a partition in the room, equipped with a control screen. This terminal is used for the entry of setpoint values and for monitoring the parameters of the operation. It is also used to manage the alarms. Advantageously, it will include resources for recording all the operational history of the installation. The installation includes an automatic on/off control loop between the air-feed system, the compressor and the intake system associated with the latter.

In the context of tablet production, two methods for operation of the installation can be envisaged.

The first, which can be called the manual mode, includes the step for entry of the temperature setpoint of the air feed. This temperature setpoint is chosen by the operator from a predetermined range of 5 to 15° C. for example. Minimum air-feed temperature of 5° C. enables one to prevent condensation phenomena that are capable of appearing below this temperature. For example, the temperature setpoint can be chosen to be equal to 10° C. This setpoint value is naturally associated with a range of tolerance (between 9 and 11° C. for example) for oscillation of the temperature around this setpoint value.

In this mode of operation, the installation controls the temperature of the gas leaving the unit 12 by means of a sensor 80 located on the shaft 16 communicating directly downstream with the latter. The installation therefore controls the unit 12, in particular its heating and cooling exchanges, so that the temperature measured by the sensor 80 remain as close as possible to the temperature setpoint, here 10° C. The probe 80 continuously reads the temperature of the air at this point. If this temperature changes, the installation controls the unit to regulate the temperature. This mode of operation is used to lower the temperature in the motor unit and the electronics unit. The temperature of the air feed in these two zones is identical to that of the air feed in the compression enclosure.

The humidity content of the gas is controlled by means of a probe 82 located alongside the downstream temperature probe 80 of the unit 12. This probe acts directly on the cold exchangers of the unit to regulate the humidity.

In this present example, the flow planned for the compression enclosure 6 is 150 m³/hour. The flows in the motor unit and the electronics unit are each designed to be to 700 m³/hour. The flow of 150 m³/hour in the compression enclosure is regulated in accordance with the vacuum that exists in the latter. In fact, this enclosure is connected to an intake system 69 performing continuous dust removal in the machine in a manner which is already familiar. This intake system is used to eliminate any excess of lubricant present in the machine. It draws in at a flow of 190 m³/hour. Since this intake system draws in more than the system feeds into the compression enclosure, and there is a permanent vacuum in the compression enclosure of between 0 and 30 Pa. This vacuum is used to confine the dust, and to prevent an excessive accumulation of dust on the machine, and any leakage of powder into the room.

The flow of air entering into the enclosure 6 is regulated in order to ensure maintenance of the vacuum. This regulation is achieved by means of the air-feed fan 9 located in the unit 12. This regulation is necessary since the intake system becomes fouled in the course of the operation, resulting in a reduction of the intake air-flow. To this end, the compression enclosure 6 is associated with a differential pressure sender 84 simultaneously measuring the pressure in the enclosure and outside it. The measurement of differential pressure performed by this sensor enables the machine to control the fan 9.

Pressure measurements are also taken continuously by means of two sensors 86 and 88, located downstream of the unit 12 and upstream of the extraction fan 14 respectively. Any variation in the speed of the fan 9 generated by the sensor 84 leads to a change in the pressure measured by the sensor 86 at the exit from the unit, and of the pressure measured by the sensor 88 in the extraction network. It is arranged that the ratio of the pressures measured by these last two sensors remains permanently constant. The installation therefore acts on the fan 14 to this end.

The intake system 69, generating an air vacuum inside the compression enclosure, is equipped with a pressure gauge measuring the differential pressure at the entrance of the intake system and outside the machine. It thus measures the rate of fouling of the intake system. When this rate reached a critical threshold, an alarm warns the operator that it is necessary to clean the filter. If this cleaning operation is not done, the machine goes into fault mode, the upstream damper 36 of the compression enclosure and the downstream dampers 70 are then shut in order to isolate the compression machine.

The other mode of operation of the process can be called the automatic mode. In this case, the operator supplies, as data to the installation, a temperature setpoint for the gas in the compression enclosure 6, of 25° C. for example, here again with a certain degree of tolerance. Thus, the system controls the unit 12 in order feed air into the enclosure 6 and to arrange that the temperature of the gas in the enclosure reaches the setpoint value. To this end, the machine includes a temperature sensor 90 placed in the enclosure. This sensor continuously measures the temperature in the enclosure. When this temperature changes from 25° C., the installation controls the unit 12, in particular the heating and cooling exchangers, in order to heat or cool the air and to return it to the temperature setpoint. This mode of operation also effects a lowering of the temperature in the motor 8 and electronics 10 units. These zones are not directly temperature controlled but are subjected indirectly to the setpoint value associated with the compression enclosure 6.

Regulation of the relative humidity is accomplished in the same manner as in manual mode. This also applies to regulation of the pressure differences.

The installation and the process according to the invention is such as to prevent the phenomena of adherence of the tablets. As can be seen, the invention consists generally of the feeding of air which has been treated beforehand (heating, cooling, filtration and controlling the relative humidity of the air) into the machine at three suitable selected points. Here it is the compression enclosure, which includes the devices for compacting the mixture, the motor unit and the electronics unit. The feeding of cold air into these last two units cools these elements, and therefore minimises the phenomenon of heat conduction toward the compression enclosure. The feeding of cold air as close as possible to the compacting zone is used to reduce the phenomenon of temperature rise generated by friction effects combined with the kinetic energy of the compression tower in motion.

Since the compressor is capable of being located in a room in which air renewal is controlled, as are all air flows, the invention has the advantage of avoiding the disruption of these flows.

Moreover, the regulation arrangements implemented by the invention for the control of temperature and flow mean that an recommendations of the production of the basic compressor can be observed (viscosity of the oil for lubrication of the various parts, the operating temperatures of the motors and electrical components, etc.).

The invention can easily be implemented by adapting an existing compressor, since this minimises the modifications to be effected. In fact, it is necessary only to drill the housing and to add the corresponding deflectors. Naturally, the invention requires auxiliary technical devices that are relatively significant, namely an air-treatment unit, a chilling unit and pipes, preferably heat-insulated, as well as automatic resources for controlling the system. The invention enables the temperature to be controlled for a relatively low cost.

Of course, it is possible to effect numerous modifications to the invention without going outside of the context of the latter.

The tablets can include a substance for therapeutic or cosmetic use other than Ibuprofen. By a substance for therapeutic use is meant a substance that can be administered for preventive or remedial purposes.

The compressor can also include at least one enclosure which is not associated with the gas feeding system.

It is also possible to include a system for humidification of the air entering into the compressor.

1. An installation comprising a machine for the production of tablets, where the machine has at least one enclosure wherein the installation includes means for injecting a gas into the enclosure and to distribute it throughout the enclosure, said means being arranged so as to control the temperature of the gas at a predetermined location upstream of the enclosure in order to ensure that the temperature of the gas in the enclosure reaches a predetermined value.

2. An installation according to claim 1, wherein said means are arranged to control the temperature of the gas at the predetermined location, in order to ensure that the temperature at this location reaches a predetermined value.

3. An installation according to claim 1, wherein said means are arranged to cool the gas.

4. An installation according to claim 1, wherein said means are arranged to heat the gas.

5. An installation according to claim 1, wherein said means are arranged to control the relative humidity of the gas.

6. An installation according to claim 1, wherein said means include at least one particle filter.

7. An installation according to claim 1, wherein said means include at least o§e fan placed upstream or downstream of the enclosure.

8. An installation according to claim 1, wherein the enclosure includes devices for shaping of the tablets.

9. An installation according to claim 1, wherein the enclosure includes a motor.

10. An installation according to claim 1, wherein the enclosure includes an electronic device.

11. An installation according to claim 1, wherein the enclosures are at least two in number, and the machine includes means for injecting a gas into each enclosure and to distribute it.

12. An installation according to claim 11, wherein it includes gas conduits arranged to feed gas to the enclosures using a parallel arrangement.

13. An installation according to any of claims 11 or 12, wherein the means are partially common to the enclosures.

14. An installation according to claim 1, wherein said means include at least one gas conduit connected so that it can be removed from the enclosure.

15. An installation according to claim 1, wherein it includes at least one stopper to interrupt the flow of gas between the enclosure and the remainder of the installation.

16. An installation according to claim 1, wherein said means are arranged to control a flow of gas associated with the enclosure by allowing the choice of one flow from various non-zero flow values.

17. An installation according to claim 1, wherein said means include a diffusion box placed in the enclosure, having at least two openings for entry of the gas into the enclosure.

18. An installation according to claim 17, wherein the openings are located on different faces of the diffusion box.

19. An installation according to claim 1, wherein the tablets include a substance for therapeutic or cosmetic use.

20. An installation according to claim 1, wherein the tablets include Ibuprofen.

21. A process for the production of tablets, wherein gas is injected into an enclosure that forms part of a machine for the production of tablets, and is distributed throughout the enclosure, and in that the temperature of the gas is controlled at a predetermined location upstream of the enclosure in order to ensure that the temperature of the gas in the enclosure reaches a predetermined value.

22. A process according to claim 21, wherein the temperature of the gas is controlled at the predetermined location in order to ensure that the temperature at this location reaches a predetermined value.

23. A method for the production of tablets, wherein a gas is fed into an enclosure that forms part of a machine for the production of tablets, and distributed throughout the enclosure.

24. A method according to claim 23, wherein the temperature of the gas is controlled.

25. A method according to claim 23, wherein the temperature of the gas is controlled at a predetermined location upstream of the enclosure, in order to ensure that the temperature of the gas in the enclosure reaches a predetermined value.

26. A method according to any of claims 23 to 25, wherein the temperature of the gas is controlled at a predetermined location upstream of the enclosure so that the temperature reaches a predetermined value.
